(19) United States
(12) Patent Application Publication
(10) Pub. No.: US 2022/0138811 A1
(43) Pub. Date: May 5, 2022

(54) AUTONOMOUS BLOCKCHAIN-BASED DONATION SYSTEM AND METHOD

(71) Applicant: E4NET CO., LTD., Seoul (KR)

(72) Inventor: Su Jeong Lee, Seoul (KR)

(21) Appl. No.: 17/324,760

(22) Filed: May 19, 2021

(30) Foreign Application Priority Data
Nov. 2, 2020 (KR) 10-2020-0144715

(51) Int. Cl. G06Q 30/02; G06Q 20/10; G06Q 20/38; H04L 9/06

(52) U.S. Cl. CPC G06Q 30/0279; G06Q 20/102; H04L 2209/38; H04L 9/0618; G06Q 20/383

(57) ABSTRACT

Disclosed are an autonomous blockchain-based donation system and a method thereof. According to the present invention, the autonomous blockchain-based donation system comprises: a campaigner terminal requesting a donation campaign; a donor terminal donating a token to the donation campaign requested by the campaigner terminal; and a donation organization terminal receiving the token donated in accordance with the donation campaign, and issuing a voucher corresponding to the received token. According to the present invention, the autonomous blockchain-based donation system and the method thereof allow each donor to be involved in deciding whether to execute a donation campaign via a blockchain-based donation process, thereby having an effect of securing the transparency of donation processes and embodying decentralization. In particular, the autonomous blockchain-based donation system can be configured to assign a donation influence to each donor based on their accumulated donations or results of their donation assessments and allow the donor to participate in deciding whether to execute a campaign agenda, thereby having an effect of enabling a donation system to autonomously operate based on rational collaborative donation processes and dispersed authority.

### CROSS-REFERENCE TO RELATED APPLICATIONS

This patent application claims priority under 35 U.S.C. § 119 to Korean Patent Application No. 10-2020-0144715 filed on Nov. 2, 2020, the entire contents of which are incorporated by reference herein.

### TECHNICAL FIELD

The present invention relates to a donation system and a method thereof and, more specifically, to an autonomous blockchain-based donation system and a method thereof.

### BACKGROUND

In most existing donation-related systems, all donee selection and donation processes are carried out under the control of donation organizations because the organizations are in charge of receiving and spending donations.

It is not easy for donors to acquire details about the spending of their donations, and moreover, they are not allowed choice in the way that their donation is spent; in other words, a donation organization-centered process is being applied.

Donors are not allowed to participate in decision-making regarding the selection of the donees, whether to spend donations, and the like.

For such reasons, there is a demand for a more transparent and decentralized donation system.

### SUMMARY

The present invention provides an autonomous blockchain-based donation system and an autonomous blockchain-based donation method.

According to the present invention, the autonomous blockchain-based donation system can be formed to include: a campaigner terminal requesting a donation campaign; a donor terminal donating a token to the donation campaign requested by the campaigner terminal; and a donation organization terminal receiving the token donated in accordance with the donation campaign, and issuing a voucher corresponding to the received token.

The autonomous blockchain-based donation system can be formed to further include: a voucher system server receiving the voucher issued by the donation organization terminal and providing the received voucher; and a beneficiary terminal receiving and using the voucher provided by the voucher system server.

Furthermore, the beneficiary terminal can be formed to allow the use of credit/debit/pre-paid/donation cards.

According to the present invention, the autonomous blockchain-based donation method can be formed to include: a step in which the campaigner terminal requests a donation campaign; a step in which the donor terminal donates a token to the donation campaign requested by the campaigner terminal; a step in which the donation organization terminal receives the token donated in accordance with the donation campaign; and a step in which the donation organization terminal issues a voucher corresponding to the received token.

The autonomous blockchain-based donation method can be formed to further include: a step in which the voucher system server receives the voucher issued by the donation organization terminal; a step in which the voucher system server provides the received voucher to the beneficiary terminal; and a step in which the use of the voucher provided to the beneficiary terminal and details thereof are managed.

According to the present invention, the autonomous blockchain-based donation system and the method thereof allow each donor to be involved in deciding whether to execute a donation campaign via a blockchain-based donation process, thereby having the effect of securing the transparency of donation processes and embodying decentralization.

In particular, the autonomous blockchain-based donation system can be configured to assign a donation influence to each donor based on their accumulated donations or results of their donation assessments, as well as allowing the donor to participate in deciding whether to execute a campaign agenda, thereby having the effect of enabling a donation system to autonomously operate based on rational collaborative donation processes and dispersed authority.

Furthermore, the present invention is capable of restricting the diversion or misuse of the donations by using the vouchers to manage and restrict the donations so that they are spent appropriately according to their original purposes.

### BRIEF DESCRIPTION OF THE DRAWINGS

FIG. 1 is a block diagram of the autonomous blockchain-based donation system in accordance with an embodiment of the present invention.

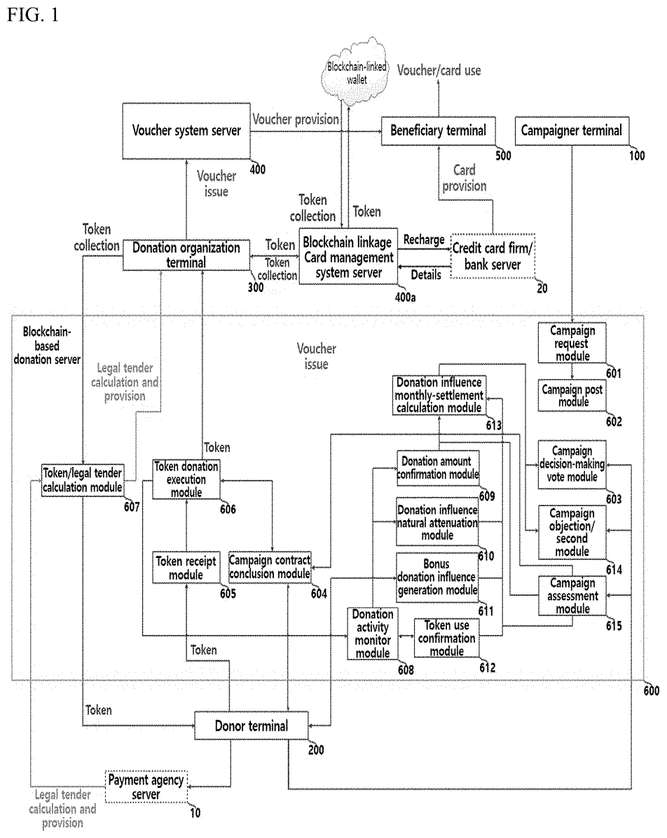

FIG. 2 is a schematic diagram indicating a process concerning an increase and a decrease in donation influences in accordance with an embodiment of the present invention.

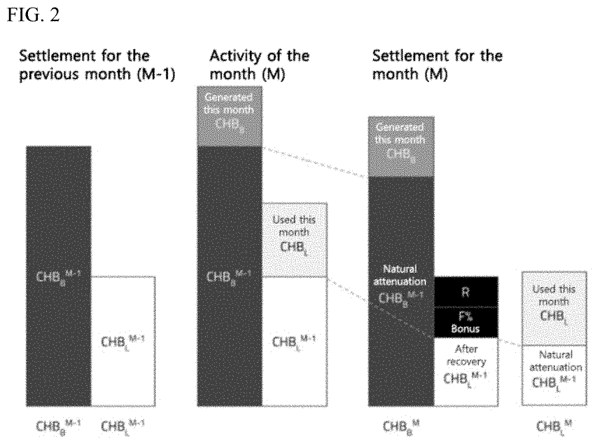

FIG. 3 is a flow chart of the autonomous blockchain-based donation method in accordance with an embodiment of the present invention.

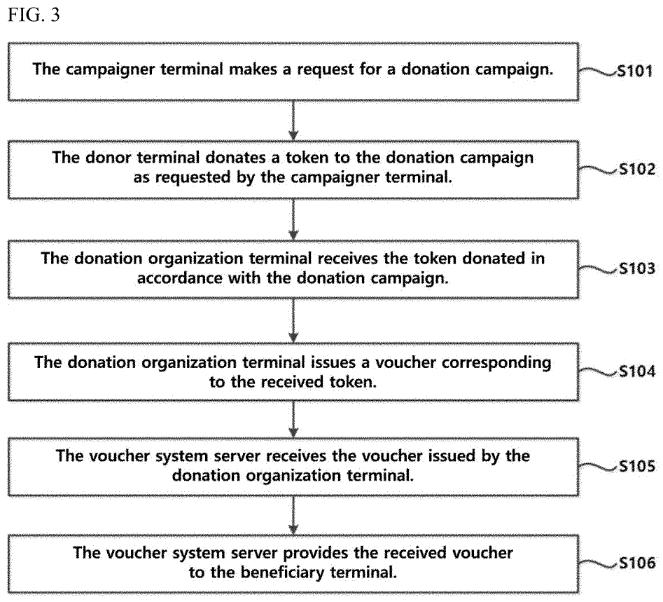

### DETAILED DESCRIPTION OF THE DISCLOSURE

The present invention is intended to cover various modifications and embodiments. Therefore, the present invention will now be further described by way of drawings demonstrating embodiments. However, the present invention should not be understood as being limited to the particular forms disclosed; the present invention should be understood as covering all modifications, equivalents, and alternatives falling within the idea and technical scope of the invention. In each drawing, matching numbers were used to refer to similar components throughout the specification.

Though terms such as “the first,” “the second,” “A,” or “B,” may be used herein to describe various components, these components should not be limited to these terms. These terms are only used to distinguish one component from another. For example, a first component could be referred to as a second component, and, similarly, a second component could be referred to as a first component without departing from the scope of rights. As used herein, the term “and/or” includes any combinations of one or more of the associated listed items.

When a component is referred to as being “connected” or “coupled” to another component, it can be directly connected or coupled to the other component, or intervening components may be present. In contrast, when a component is referred to as being “directly connected” or “directly coupled” to another component, there are no intervening components present.

The terminology used herein is for the purpose of describing particular embodiments only and is not intended to limit the scope of the present invention. Singular forms are intended to include plural forms as well, unless the context clearly indicates otherwise. The terms “include” and/or “comprise” specify the presence of stated features, numerals, steps, operations, components, parts, or combinations thereof, but do not preclude the presence or addition of one or more other features, numerals, steps, operations, components, components, or combinations thereof.

Unless otherwise defined, all the terms, including technical and scientific terms, used herein have the same meaning as commonly understood by one of ordinary skill in the art to which this inventive concept belongs. Terms, such as those defined in commonly used dictionaries, should be interpreted as having a meaning that is consistent with their meaning in the context of the relevant art and will not be interpreted in an idealized or overly formal sense unless expressly defined as such herein.

Hereinafter, a preferred embodiment according to the present invention will be further described with reference to the accompanying drawings.

Drawing 1 is a block diagram of the autonomous blockchain-based donation system in accordance with one embodiment of the present invention, and Drawing 2 is a mimetic diagram indicating a process concerning an increase and a decrease in donation influences in accordance with one embodiment of the present invention.

Referring to Drawing 1, the autonomous blockchain-based donation system according to one embodiment of the present invention can be formed to include a campaigner terminal (100), a donor terminal (200), a donation organization terminal (300), a voucher system server (400), a blockchain-linked card management system server (400a), a beneficiary terminal (500), and a blockchain-based donation server (600).

Hereinafter, the components of the embodiment will be further described.

The campaigner terminal (100) can be formed to make a request for a donation campaign. Here, the donation campaign may include contents such as a donation purpose, a target fund-raising amount, activity details, expense/execution plans, expected effects, and the like.

The donor terminal (200) can be formed to donate a token to the donation campaign requested by the campaigner terminal (100).

The donation organization terminal (300) can be formed to receive the token donated in accordance with the donation campaign, and then issue a voucher corresponding to the received token.

The voucher system server (400) can be formed to receive the voucher issued by the donation organization terminal (300), and then provide the received voucher to the beneficiary terminal (500).

The blockchain-linked card management system server (400a) can be formed to make a request for card-recharging by sending a deposit to a credit card firm/bank server (20) within the scope of the token of the donation organization terminal (300). Here, the token corresponding to the deposit can be recorded in a blockchain-linked wallet. Furthermore, a credit card firm/bank can provide corresponding credit/debit/pre-paid/donation cards to a beneficiary.

The blockchain-linked card management system server (400a) can be formed to receive details about use of the credit/debit/pre-paid/donation cards used through the beneficiary terminal (500) from the credit card firm/bank server (20) and collect the token of the blockchain-linked wallet in accordance with the corresponding details about the card use.

As such, the blockchain-linked card management system server (400a) can be formed to enable the beneficiary to use the cards within the scope of the donated token through the blockchain-linked wallet linked with the details about the use of the credit/debit/pre-paid/donation cards used by the beneficiary.

The beneficiary terminal (500) can be formed to receive and use the voucher provided from the voucher system server (400).

Further, the beneficiary terminal (500) can be formed to receive and use the credit/debit/pre-paid/donation cards provided by the credit card firm/bank server (20) through the blockchain-linked card management system server (400a).

The blockchain-based donation server (600) can be formed to conclude a donation campaign contract for the donation campaign requested by the campaigner terminal (100), based on a blockchain.

Furthermore, the blockchain-based donation server (600) can be formed to receive the token from the donor terminal (200) and provide the same to the donation organization terminal (300) in regard to the concluded donation campaign contract.

The blockchain-based donation server (600) can be formed to include a campaign request module (601), a campaign post module (602), a campaign decision-making vote module (603), a campaign contract conclusion module (604), a token receipt module (605), a token donation execution module (606), a token/legal tender calculation module (607), a donation activity monitor module (608), a donation amount confirmation module (609), a donation influence natural-attenuation module (610), a bonus donation influence generation module (611), a token use confirmation module (612), a donation influence monthly settlement calculation module (613), a campaign objection/second module (614), and a campaign assessment module (615).

Hereinafter, the components of the embodiment will be further described.

The campaign request module (601) can be formed to receive a request for a donation campaign from the campaigner terminal (100).

The campaign post module (602) can post the donation campaign requested from the campaign request module (601) or send the same by email such that each donor terminal (200) can confirm the same.

The campaign decision-making vote module (603) can be formed to carry out voting by receiving decision-making votes from each donor terminal (200) with respect to the donation campaign posted by the campaign post module (602).

The campaign contract conclusion module (604) can be formed to conclude the corresponding donation campaign contract in accordance with the decision-making voting carried out by the campaign decision-making vote module (603). Here, the decision-making voting can be conducted after applying a weighted value depending on the donation influence of each donor.

The token receipt module (605) can be formed to receive a token from the corresponding donor terminal (200) in regard to the donation campaign contract concluded through the campaign contract conclusion module (604).

The token donation execution module (606) can be formed to carry out the donation by providing the token received from the token receipt module (605) to the corresponding donation organization terminal (300).

The token/legal tender calculation module (607) can be formed to take back the token, which is provided from the token donation execution module (606), from the donation organization terminal (300) and receive a request for legal tender calculation.

Furthermore, the token/legal tender calculation module (607) can be formed to calculate an amount of legal tender corresponding to the received request for legal tender calculation and provide the same to the donation organization terminal (300).

Meanwhile, the donor terminal (200) can be formed to calculate and provide an amount of legal tender corresponding to the donated token to the token/legal tender calculation module (607) through a payment agency server (10) prior to the legal tender calculation procedure of the token/legal tender calculation module (607).

The donation activity monitor module (608) can be formed to monitor the donation activities of the donor terminal (200).

The donation amount confirmation module (609) can be formed to confirm a donation amount from the donor terminal (200), as a monitoring result of the donation activity monitor module (608), and increase the donation influence of the corresponding donor by the confirmed donation amount.

The donation influence natural-attenuation module (610) can be formed to cause the donation influence of the corresponding donor to be naturally attenuated by half if there is no donation activity as a result of the monitoring of the donation activity monitor module (608). Referring to Drawing 2, it is shown that if there is no donation from the donor, the donation influence of the donor becomes naturally attenuated by half.

The bonus donation influence generation module (611) can be formed to generate and grant a bonus donation influence to a corresponding donor, as shown in Drawing 2, if there is a donation activity as a result of the monitoring of the donation activity monitor module (608).

The token use confirmation module (612) can be formed to reduce the donation influence of the corresponding donor through a used token, as in Drawing 2, if the use of the token is found as a result of the monitoring of the donation activity monitor module (608).

The donation influence monthly settlement calculation module (613) can be formed to calculate a donation influence by settling, on a monthly basis with respect to each donor, the donation influence increased by the donation amount confirmation module (609), the donation influence naturally attenuated by the donation influence natural-attenuation module (610), the bonus donation influence granted by the bonus donation influence generation module (611), and the donation influence reduced by the token use confirmation module (612).

Meanwhile, the donation influence monthly settlement calculation module (613) can also increase a donation influence with respect to a token generated anew for each donor.

In other words, the monthly settlement donation influence can be calculated in accordance with the following equation (Equation 1).

Settled donation influence this month=Settled donation influence of the previous month*(1 2^{-1/N})+Newly generated donation influence−Spent donation influence [EQUATION 1]

Here, N is the number of months, and an N-value may be determined in accordance with a policy.

A campaign objection/second module (614) can be formed to raise an objection by a predetermined donor terminal (200) to a donation campaign posted by the campaign post module (602) or to second a donation campaign to which another donor terminal is objecting. Each donor can autonomously take part by raising an objection to the execution of a donation campaign or by seconding the campaign. In other words, decentralization, as well as the dispersion of power, can be brought about in relation to the execution of donation, the selection of donees, a target amount, and the like.

Here, if voting is required after seconding, the donor terminal (200) can participate in the voting by betting a possessed donation influence. The donor terminal (200) winning the voting can be formed to obtain donation influence from losing donor terminals (200) by a ratio of the donation influence used for the voting.

Furthermore, the campaign decision-making vote module (603) can be formed to carry out decision-making voting by applying a weighted value to yes-or-no decision-making votes depending on the donation influence of each donor calculated by the donation influence monthly settlement calculation module (613).

The campaign assessment module (615) is formed to carry out the assessment for selecting appropriate campaigns. The campaign assessment module (615) can be formed to carry out a form of assessment in which scores are given in proportion to a predetermined amount of donation influences bet by the donor terminal (200) on the corresponding campaign, wherein a higher score can be obtained as an assessment result is closer to a final intermediate value of participating donor terminals (200). The donation influence used for the assessment can be formed to gradually recover to its original state as time goes on.

Drawing 3 is a flow chart of the autonomous blockchain-based donation method in accordance with an embodiment of the present invention.

According to Drawing 3, the method comprises the following steps: campaigner terminal (100) requests a donation campaign (S101);

the donor terminal (200) donates a token to the donation campaign as requested by the campaigner terminal (100) (S102);

the donation organization terminal (300) receives the token donated in accordance with the donation campaign (S103);

the donation organization terminal (300) issues a voucher corresponding to the received token (S104);

the voucher system server (400) receives the voucher issued by the donation organization terminal (200) (S105);

and the voucher system server (400) provides the received voucher to the beneficiary terminal (500) (S106).

While this disclosure has been particularly shown and described with reference to embodiments thereof, it should be understood that various changes in form and details may be made therein without departing from the spirit and scope of the following claims.

What is claimed is:

1. An autonomous blockchain-based donation system comprising:
a campaigner terminal requesting a donation campaign;
a donor terminal donating a coin to the donation campaign as requested by the campaigner terminal;
a donation organization terminal receiving the coin donated in accordance with the donation campaign, and then issuing a voucher corresponding to the received coin;
a voucher system server receiving the voucher issued by the donation organization terminal, and then providing the received voucher;
a blockchain-linked card management system server requesting a card recharge by sending a deposit to a credit card firm/bank server within the scope of the token of the donation organization terminal, and then collecting the token of a blockchain-linked wallet of the corresponding donation organization in accordance with details about use of a corresponding recharged card;
a beneficiary terminal receiving and using the voucher provided from the voucher system server, or credit/debit/pre-paid/donation cards provided from the credit card firm/bank server, through the blockchain-linked card management system server;
and a blockchain-based donation server concluding a donation campaign contract for the donation campaign as requested by the campaigner terminal, and then receiving the coin from the donor terminal and providing the same to the donation organization terminal in regard to the concluded donation campaign contract, wherein
the blockchain-based donation server comprises:
a campaign request module receiving a request for a donation campaign from the campaigner terminal;
a campaign post module posting the donation campaign requested through the campaign request module;
a campaign decision-making vote module carrying out voting by receiving decision-making votes from each donor terminal with respect to the donation campaign posted by the campaign post module;
a campaign contract conclusion module concluding the corresponding donation campaign contract in accordance with the decision-making voting carried out by the campaign decision-making vote module;
a coin receipt module receiving a coin from the corresponding donor terminal in regard to the donation campaign contract concluded through the campaign contract conclusion module;
a coin donation execution module carrying out the donation by providing the coin received from the token receiving module to the corresponding donation organization terminal;
a coin/cash calculation module receiving a request for cash calculation from the donation organization terminal with respect to the coin provided from the coin donation execution module, and then calculating and providing a cash amount corresponding to the received request for cash calculation;
a donation activity monitor module monitoring donation activities of the donor terminal;
a donation amount confirmation module confirming donation amount from the donor terminal, as a result of the monitoring of the donation activity monitor module, and increasing a donation influence of the corresponding donor by the confirmed donation amount;
a donation influence natural-attenuation module causing the donation influence of the corresponding donor to be naturally attenuated by half if there is no donation activity, as a result of the monitoring of the donation activity monitor module;
a bonus donation influence generation module generating and granting a bonus donation influence to the corresponding donor if there is a donation activity, as a result of the monitoring of the donation activity monitor module;
a coin use confirmation module reducing the donation influence of the corresponding donor by the used coin if the used coin is found, as a result of the monitoring of the donation activity monitor module;
a donation influence monthly settlement calculation module calculating a donation influence by settling, on a monthly basis with respect to each donor, the donation influence increased by the donation amount confirmation module, the donation influence naturally attenuated by the donation influence natural-attenuation module, the bonus donation influence granted by the bonus donation influence generation module, and the donation influence reduced by the token use confirmation module;
a campaign objection/second module raising an objection by a predetermined donor terminal to a donation campaign posted by the campaign post module or to second a donation campaign to which another donor terminal is objecting;
and a campaign assessment module assessing the donation campaign based on each donor terminal in accordance with the objection or second raised by the campaign objection/second module, wherein
the donation influence monthly settlement calculation module is formed to,
apply a higher score to a donation influence of a corresponding donor as the assessment of a donor terminal is closer to a final mid-score, as a result of assessment by the campaign assessment module, wherein
the campaign decision-making vote module is formed to,
conduct decision-making voting by applying a weighted value to decision-making votes depending on the monthly settlement donation influence of each donor calculated by the donation influence monthly settlement calculation module, wherein
the donor terminal is formed to,
calculate and provide a cash amount corresponding to the donated coin to the coin/cash calculation module through a payment agency server during the cash calculation procedure of the coin/cash calculation module.

2. The autonomous blockchain-based donation system of claim 1,
wherein the campaign decision-making vote module is formed to grant authority determined by the natural half-attenuation method, by receiving the decision-making votes and enabling autonomous participants to automatically make a decision among themselves.

3. The autonomous blockchain-based donation system of claim 2,
wherein the donation influence monthly settlement calculation module is formed to calculate monthly settlement donation influence for each donor in accordance with a degree of contribution and the natural half-attenuation method.
